(19) United States
(12) Patent Application Publication
(10) Pub. No.: US 2024/0086295 A1
(43) Pub. Date: Mar. 14, 2024

(54) COMMUNICATION PERIOD DETERMINATION DEVICE, COMMUNICATION PERIOD DETERMINATION METHOD, AND COMPUTER READABLE MEDIUM

(71) Applicant: Mitsubishi Electric Corporation, Tokyo (JP)

(72) Inventors: Tomotaka OGAWA, Tokyo (JP); Daisuke OSAGAWA, Tokyo (JP)

(73) Assignee: Mitsubishi Electric Corporation, Tokyo (JP)

(21) Appl. No.: 18/516,569

(22) Filed: Nov. 21, 2023

Related U.S. Application Data
(63) Continuation of application No. PCT/JP2021/024381, filed on Jun. 28, 2021.

(51) Int. Cl. G06F 11/34; G06F 9/30; G06F 9/32

(52) U.S. Cl. CPC G06F 11/34; G06F 9/3001; G06F 9/30058; G06F 9/321

(57) ABSTRACT

A counter variable search unit (121) finds a counter variable from a control program. A remainder operation search unit (122) finds a remainder operation on the counter variable from the control program. A branch instruction search unit (123) finds a conditional branch instruction on a remainder of the remainder operation from the control program. An input/output variable extraction unit (124) extracts an input/output variable from a branch destination block of the conditional branch instruction. A target equipment identification unit (125) identifies target equipment to or from which a value of the extracted input/output variable is input or output. A communication period determination unit (126) determines a communication period of the identified target equipment.

### CROSS REFERENCE TO RELATED APPLICATION

This application is a Continuation of PCT International Application No. PCT/JP2021/024381, filed on Jun. 28, 2021, which is hereby expressly incorporated by reference into the present application.

### TECHNICAL FIELD

The present disclosure relates to a technique for determining a communication period of equipment controlled by a control program.

### BACKGROUND ART

A control system generally includes a control device and target equipment. The control device executes a control program. The control device and the target equipment are connected through an FA network.

FA is an abbreviation for factory automation.

The target equipment includes, for example, remote input equipment and remote output equipment.

The remote input equipment inputs a state of a switch or a state of a sensor to the control device.

The remote output equipment drives a solenoid and a lamp in accordance with an output of the control device.

In the following, the remote input equipment and the remote output equipment will be collectively called remote input/output equipment if there is no problem.

The control system also includes a setting device. The setting device sets, in the control device, the control program or information on operation of the FA network, for example. The information is input by a user.

The setting device is connected to the control device as required.

The control program is a program in which control operation desired by the user is written.

In the control program, instruction rows are arranged each of which specifies a target of processing, an output destination of a processing result, and content of processing.

The control device is given an I/O variable list together with the control program. I/O is an abbreviation for input/output.

I/O variables are variables used in the control program, and each I/O variable corresponds to a piece of the remote input/output equipment.

The I/O variable list indicates, for each I/O variable, an I/O variable and a corresponding piece of the remote input/output equipment.

Some FA networks have a periodic communication function using a time-division communication technique.

In the periodic communication function using the time-division communication technique, the communication band of a network is time-divided, and time frames of a communication period having a pre-determined time length are provided so as to perform communication whose details are predetermined.

When periodic communication is not performed, other types of communication can use the network.

The values of input/output variables are updated using periodic communication.

Periodic communication is performed independently of execution of the control program.

In periodic communication, input data acquired from the remote input equipment is saved in a temporary storage device inside the control device, and the value of the input data is referenced by the control program as the value of an input/output variable. In addition, the value of an input/output variable manipulated by the control program is saved in the temporary storage device and is transmitted to the remote output equipment through periodic communication.

If the period of periodic communication is too short relative to that assumed by the control program, a situation will occur in which in periodic communication even if input data from the remote input equipment is saved in the temporary storage device, the control program does not reference the input data. A situation will also occur in which output data not manipulated by the control program is transmitted to the remote output equipment through periodic communication.

In such a case, no problem will occur in control, but the network band will be wasted.

On the other hand, if the period of periodic communication that is actually performed is too long relative to that assumed by the control program, a situation will occur in which the control program references the value of an I/O variable that is old. A situation will also occur in which the value of an I/O variable manipulated by the control program is not reflected in the remote output equipment.

In such a case, a problem will occur in control.

Therefore, the period of periodic communication needs to be set to an appropriate value in line with the assumption by the control program.

In conventional art, the execution period of the control program is set according to the communication period.

Patent Literature 1 discloses a servo system.

In the servo system, a host device and a plurality of servo amplifiers are connected by synchronous serial communication means. In the synchronous serial communication means, data is exchanged with regard to operation commands and so on with a fixed communication period. The host device serves as a control device. The periods of operations executed in the host device are synchronized with 1/n times (where n is an integer) of the communication period.

### CITATION LIST

### Patent Literature

Patent Literature 1: JP 2008-176673 A

### SUMMARY OF INVENTION

### Technical Problem

The control program is generally executed repeatedly with a fixed period.

The control program may include processing that is executed each time the control program is executed and processing that is executed only once while the control program is executed several times.

If an appropriate communication period is set for equipment corresponding to an I/O variable according to the execution frequency of processing on the I/O variable in the control program, the amount of data exchanged in periodic communication will be reduced.

However, it is a heavy burden for a user to check the execution frequency of processing for each I/O variable, and determine an appropriate communication period for equipment corresponding to each I/O variable.

An object of the present disclosure is to make it possible to obtain an appropriate communication period for target equipment that is accessed only once while a control program is executed a plurality of times.

### Solution to Problem

A communication period determination device according to the present disclosure includes
a counter variable search unit to find, from a control program for controlling one or more pieces of target equipment, a counter variable for counting the number of times the control program is executed;
a remainder operation search unit to find, from the control program, a remainder operation in which the counter variable is a dividend and a constant is a divisor;
a branch instruction search unit to find, from the control program, a conditional branch instruction whose branch condition is a match between a remainder of the remainder operation and a constant;
an input/output variable extraction unit to extract an input/output variable from a branch destination block of the conditional branch instruction;
a target equipment identification unit to identify, from among the one or more pieces of target equipment, a piece of target equipment to or from which a value of the extracted input/output variable is input or output; and
a communication period determination unit to determine a time period obtained by multiplying an execution period of the control program by the divisor of the remainder operation as a communication period of the identified piece of target equipment when the extracted input/output variable is accessed in only one branch destination block.

### Advantageous Effects of Invention

According to the present disclosure, an appropriate communication period can be obtained for target equipment that is accessed only once while a control program is executed a plurality of times.

### BRIEF DESCRIPTION OF DRAWINGS

FIG. 1 is a configuration diagram of a control system 200 in Embodiment 1;

FIG. 2 is a configuration diagram of a communication period determination device 100 in Embodiment 1;

FIG. 3 is a flowchart of a communication period determination method in Embodiment 1;

FIG. 4 is a figure illustrating an example of a control program 191 in Embodiment 1;

FIG. 5 is a figure illustrating an example of an input/output variable list 192 in Embodiment 1;

FIG. 6 is a flowchart of step S120 in Embodiment 1;

FIG. 7 is a flowchart of step S120 in Embodiment 1;

FIG. 8 is a figure illustrating an example of a counter variable list 193 in Embodiment 1;

FIG. 9 is a flowchart of step S130 in Embodiment 1;

FIG. 10 is a figure illustrating an example of a remainder variable list 194 in Embodiment 1;

FIG. 11 is a flowchart of step S140 in Embodiment 1;

FIG. 12 is a flowchart of step S140 in Embodiment 1;

FIG. 13 is a figure illustrating an example of a remainder branch block list 195 in Embodiment 1;

FIG. 14 is a flowchart of step S150 in Embodiment 1;

FIG. 15 is a flowchart of step S150 in Embodiment 1;

FIG. 16 is a figure illustrating an example of a remainder branch access destination list 196 in Embodiment 1;

FIG. 17 is a figure for describing periodic communication in Embodiment 1;

FIG. 18 is a figure for describing periodic communication in Embodiment 1;

FIG. 19 is a figure for supplementarily describing a control program in Embodiment 1;

FIG. 20 is a figure for supplementarily describing the control program in Embodiment 1;

FIG. 21 is a flowchart of a communication period determination method in Embodiment 2;

FIG. 22 is a configuration diagram of the communication period determination device 100 in Embodiment 3;

FIG. 23 is a flowchart of a communication period determination method in Embodiment 3;

FIG. 24 is a figure illustrating an example of a specified variable list 197 in Embodiment 3;

FIG. 25 is a configuration diagram of the communication period determination device 100 in Embodiment 4;

FIG. 26 is a flowchart of a communication period determination method in Embodiment 4;

FIG. 27 is a figure illustrating an example of a specified branch list 198 in Embodiment 4;

FIG. 28 is a figure illustrating an example of a flowchart of a control program in Embodiment 4;

FIG. 29 is a figure illustrating an example of a flowchart of a control program in Embodiment 4; and

FIG. 30 is a hardware configuration diagram of the communication period determination device 100 in the embodiments.

### DESCRIPTION OF EMBODIMENTS

In the embodiments and drawings, the same elements or corresponding elements are denoted by the same reference sign. Description of an element denoted by the same reference sign as that of an element that has been described will be suitably omitted or simplified. Arrows in figures mainly indicate flows of data or flows of processing.

### Embodiment 1

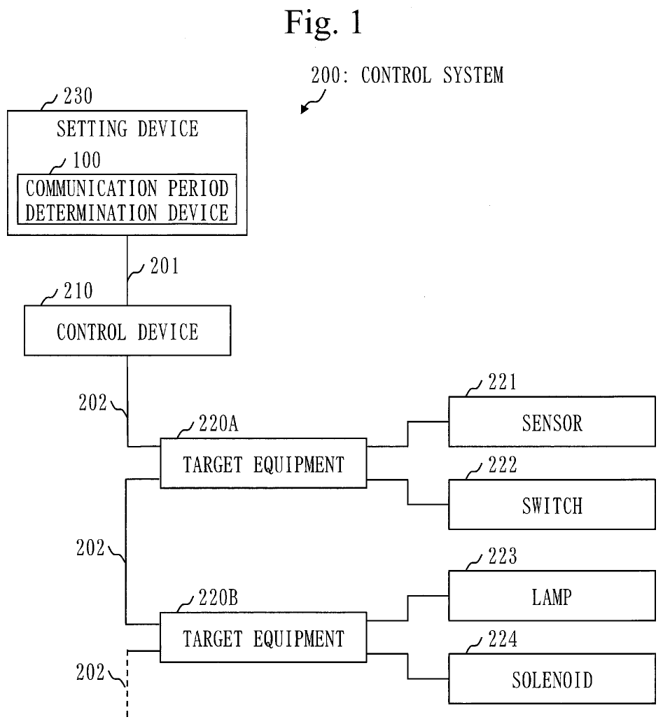

A control system 200 will be described based on FIGS. 1 to 20.

*** Description of Configurations ***

Based on FIG. 1, a configuration of the control system 200 will be described.

A specific example of the control system 200 is factory automation (FA).

The control system 200 includes a control device 210, one or more pieces of target equipment 220, and a setting device 230.

The setting device 230 and the control device 210 are connected through a network 201.

The control device 210 and one or more pieces of the target equipment 220 are connected through a network 202. The network 202 is a communication line that adopts a time division method. Real-time performance is guaranteed between the control device 210 and one or more pieces of the target equipment 220. In FIG. 1, the control device 210 and two pieces of the target equipment (220A, 220B) are connected in a daisy chain form, but the control device 210 and one or more pieces of the target equipment 220 may be connected using other topologies, such as a tree form or a star form.

A sensor 221, a switch 222, a lamp 223, a solenoid 224, and the like are connected to one piece of the target equipment 220.

The control device 210 is a computer that includes hardware such as a processor, a memory, an auxiliary storage device, a communication device, and an input/output interface.

The control device 210 controls one or more pieces of the target equipment 220 by executing a control program according to operation parameters.

Each of one or more pieces of the target equipment 220 is equipment to be controlled by the control device 210. The target equipment 220A is equipment called a remote input device, and the target equipment 220B is equipment called a remote output device.

The target equipment 220A acquires state data indicating a state from each of the sensor 221 and the switch 222, and inputs the acquired state data to the control device 210.

The target equipment 220B drives each of the lamp 223 and the solenoid 224 in accordance with command data input from the control device 210.

The setting device 230 is a device that sets the control program and the operation parameters in the control device 210. Specifically, the setting device 230 functions as a communication period determination device 100.

The communication period determination device 100 determines a communication period of each of one or more pieces of the target equipment 220. The communication period is one of the operation parameters.

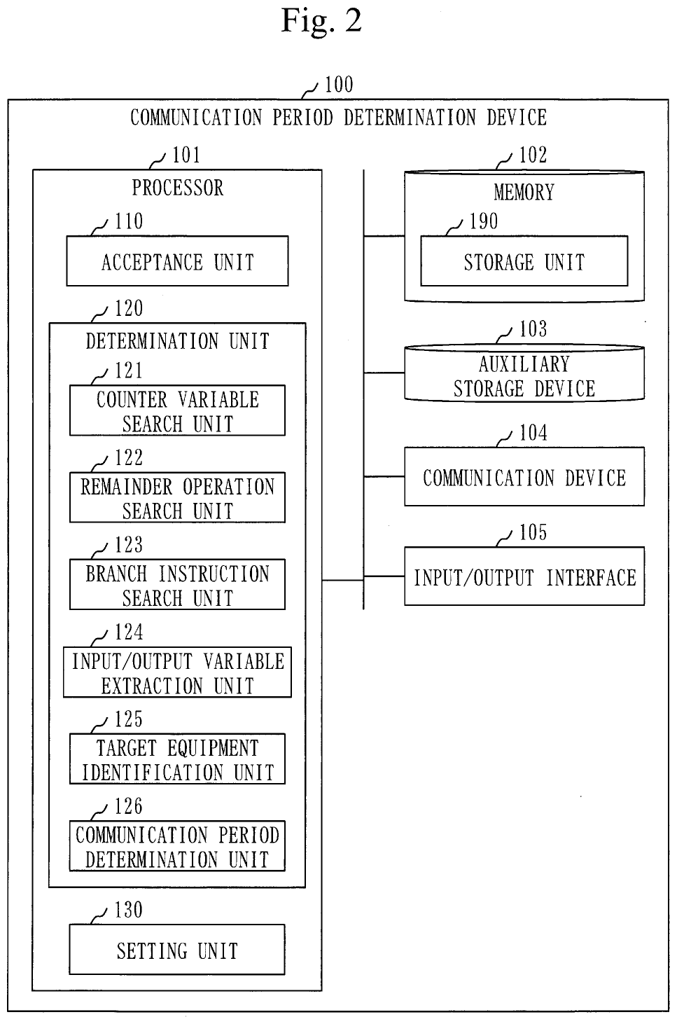

Based on FIG. 2, a configuration of the communication period determination device 100 will be described.

The communication period determination device 100 is a computer that includes hardware such as a processor 101, a memory 102, an auxiliary storage device 103, a communication device 104, and an input/output interface 105. These hardware components are connected with one another through signal lines.

The processor 101 is an IC that performs operational processing and controls other hardware components. For example, the processor 101 is a CPU.

IC is an abbreviation for integrated circuit.

CPU is an abbreviation for central processing unit.

The memory 102 is a volatile or non-volatile storage device. The memory 102 is also called a main storage device or a main memory. For example, the memory 102 is a RAM. Data stored in the memory 102 is saved in the auxiliary storage device 103 as necessary.

RAM is an abbreviation for random access memory.

The auxiliary storage device 103 is a non-volatile storage device. For example, the auxiliary storage device 103 is a ROM, an HDD, or a flash memory. Data stored in the auxiliary storage device 103 is loaded into the memory 102 as necessary.

ROM is an abbreviation for read only memory.

HDD is an abbreviation for hard disk drive.

The communication device 104 is a receiver and a transmitter. For example, the communication device 104 is a communication chip or a NIC. Communication of the communication period determination device 100 is performed using the communication device 104.

NIC is an abbreviation for network interface card.

The input/output interface 105 is a port to which an input device and an output device are connected. For example, the input/output interface 105 is a USB terminal, the input device is a keyboard and a mouse, and the output device is a display. Input to and output from the communication period determination device 100 are performed using the input/output interface 105.

USB is an abbreviation for Universal Serial Bus.

The processor 101 includes elements such as an acceptance unit 110, a determination unit 120, and a setting unit 130. The determination unit 120 includes elements such as a counter variable search unit 121, a remainder operation search unit 122, a branch instruction search unit 123, an input/output variable extraction unit 124, a target equipment identification unit 125, and a communication period determination unit 126. These elements are realized by software.

The auxiliary storage device 103 stores a communication period determination program to cause a computer to function as the acceptance unit 110, the determination unit 120, and the setting unit 130. The communication period determination program is loaded into the memory 102 and executed by the processor 101.

The auxiliary storage device 103 further stores an OS. At least part of the OS is loaded into the memory 102 and executed by the processor 101.

The processor 101 executes the communication period determination program while executing the OS.

OS is an abbreviation for operating system.

Input data and output data of the communication period determination program are stored in a storage unit 190.

The memory 102 functions as the storage unit 190. However, a storage device such as the auxiliary storage device 103, a register in the processor 101, and a cache memory in the processor 101 may function as the storage unit 190 in place of the memory 102 or together with the memory 102.

The communication period determination device 100 may include a plurality of processors as an alternative to the processor 101.

The communication period determination program can be recorded (stored) in a computer readable format in a non-volatile recording medium such as an optical disc or a flash memory.

*** Description of Operation ***

A procedure for operation of the communication period determination device 100 is equivalent to a communication period determination method. The procedure for operation of the communication period determination device 100 is also equivalent to a procedure for processing by the communication period determination program.

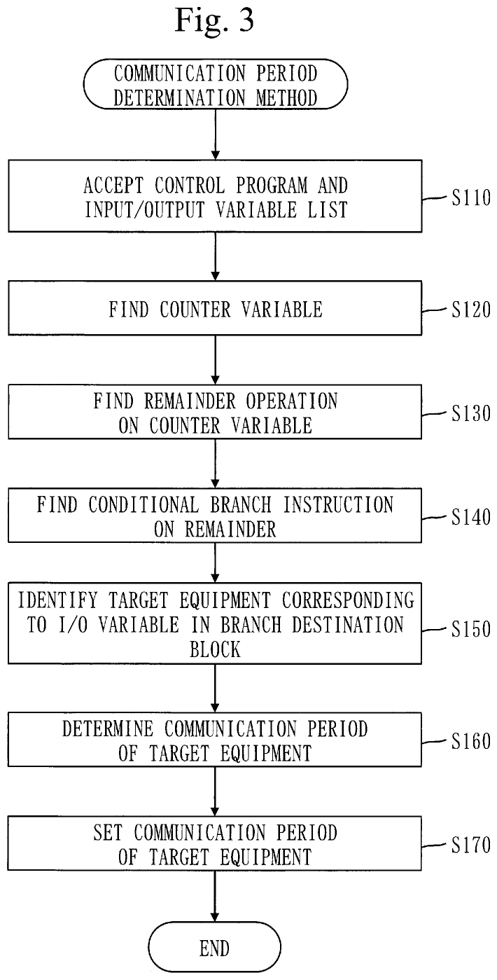

Based on FIG. 3, the communication period determination method will be described.

In step S110, the acceptance unit 110 accepts a control program 191 and an input/output variable list 192.

For example, a user inputs the control program 191 to the communication period determination device 100, and the acceptance unit 110 accepts the control program 191 that has been input.

The control program 191 has the following characteristics.
(1) The control program 191 is written without violations of syntax and rules.
(2) The execution period of the control program 191 is equal to a base communication period. The base communication period will be referred to as a “periodic communication period” and represented by “T”.
(3) The control program 191 does not contain an infinite loop inside. This characteristic (3) is related to the characteristic (2).
(4) In the control program 191, a branch is composed of a “branch instruction”, a “start instruction”, and an “end instruction”. The branch instruction is an instruction that determines whether or not a branch condition is satisfied. The start instruction denotes start of a branch destination block. The end instruction denotes end of the branch destination block.
(5) In the control program 191, one or more instructions are written sequentially. Therefore, an “n-th instruction” uniquely identifies one place in the control program 191. “n” is a positive integer.

The input/output variable list 192 indicates, for each input/output variable, the target equipment 220 corresponding to the input/output variable.

The value of the input/output variable is input to and output from the target equipment 220 corresponding to the input/output variable.

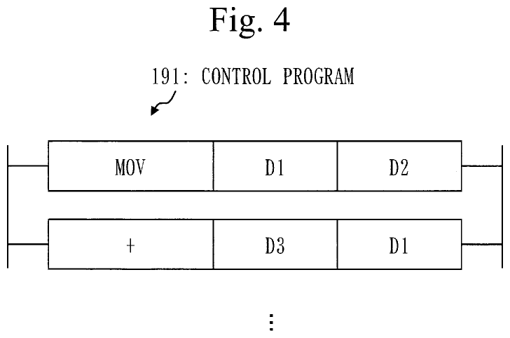

FIG. 4 illustrates an example of the control program 191.

In the control program 191, instruction rows are arranged each of which specifies a target of processing, an output destination of a processing result, and content of processing.

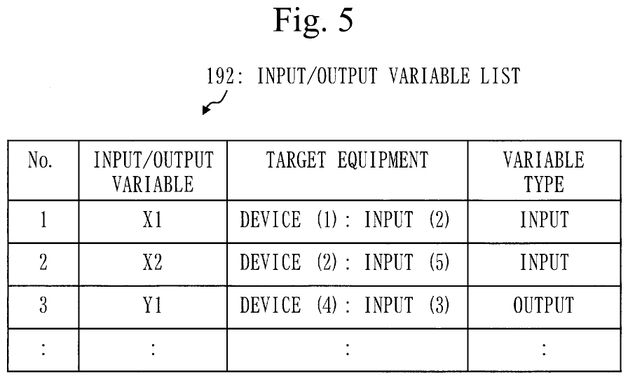

FIG. 5 illustrates an example of the input/output variable list 192.

The input/output variable list 192 indicates, for each input/output variable, a set of an input/output variable, the target equipment 220, and a variable type.

The column of the target equipment 220 indicates the name of the target equipment 220 and also the name of an input/output interface to which the input/output variable is input.

The variable type is a type of the input/output variable (input or output).

In step S120, the counter variable search unit 121 finds a counter variable in the control program 191.

The counter variable is a variable for counting the number of times the control program 191 is executed.

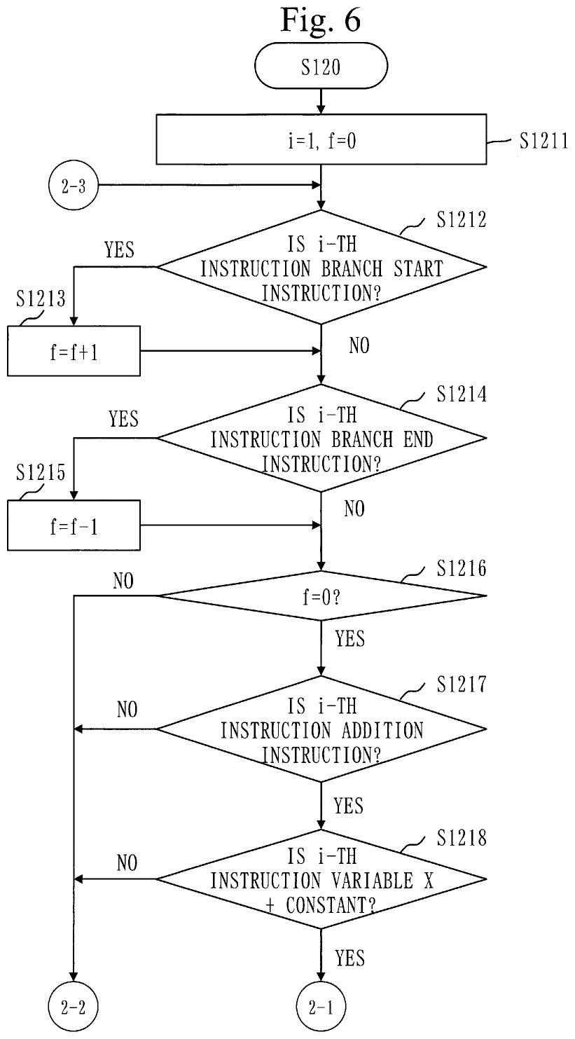

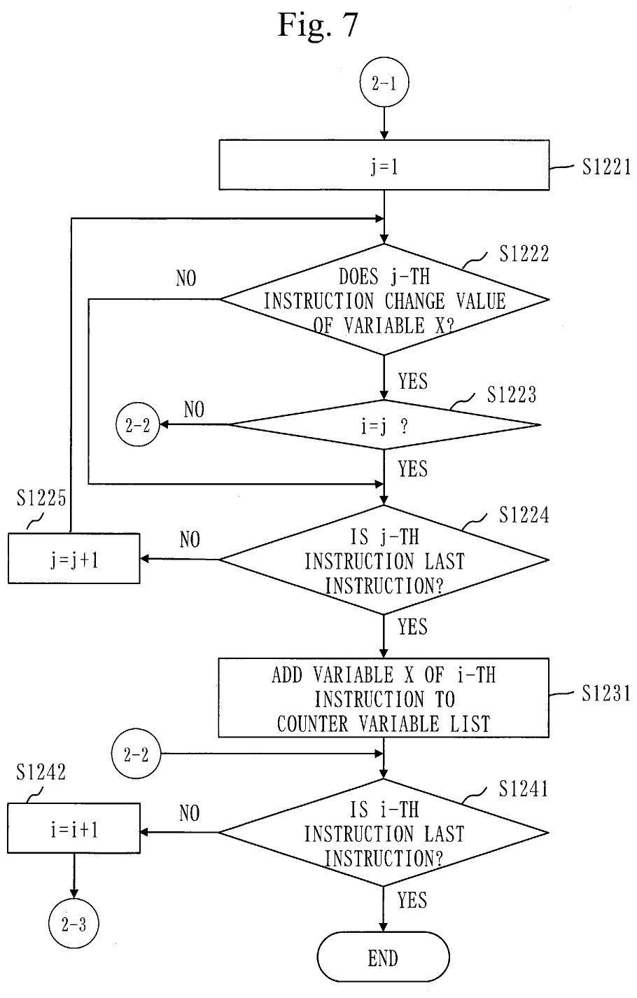

Based on FIGS. 6 and 7, a procedure for step S120 will be described.

In step S1211, the counter variable search unit 121 sets an initial value 1 in a temporary variable i, and sets an initial value 0 in a temporary variable f.

In steps S1212 to S1216, the counter variable search unit 121 uses the temporary variable f to determine whether an i-th instruction in the control program 191 is an instruction that is executed only once.

A branch start instruction and a branch end instruction are not instructions that are executed only once.

In step S1212, the counter variable search unit 121 selects the i-th instruction from the control program 191.

Then, the counter variable search unit 121 determines whether the i-th instruction is a branch start instruction. That is, the counter variable search unit 121 determines whether the i-th instruction denotes start of a branch destination block.

If the i-th instruction is a branch start instruction, processing proceeds to step S1213.

If the i-th instruction is not a branch start instruction, processing proceeds to step S1214.

In step S1213, the counter variable search unit 121 adds 1 to the value of the temporary variable f.

After step S1213, processing proceeds to step S1214.

In step S1214, the counter variable search unit 121 determines whether the i-th instruction is a branch end instruction. That is, the counter variable search unit 121 determines whether the i-th instruction denotes end of a branch destination block.

If the i-th instruction is a branch end instruction, processing proceeds to step S1215.

If the i-th instruction is not a branch end instruction, processing proceeds to step S1216.

In step S1215, the counter variable search unit 121 subtracts 1 from the value of the temporary variable f.

After step S1215, processing proceeds to step S1216.

In step S1216, the counter variable search unit 121 determines whether the value of the temporary variable f is 0.

If the value of the temporary variable f is 0, processing proceeds to step S1217.

If the value of the temporary variable f is not 0, processing proceeds to step S1241.

In step S1217, the counter variable search unit 121 determines whether the i-th instruction is an addition instruction.

If the i-th instruction is an addition instruction, processing proceeds to step S1218.

If the i-th instruction is not an addition instruction, processing proceeds to step S1241.

In step S1218, the counter variable search unit 121 determines whether the i-th instruction is an addition instruction of a variable X and a constant. The variable X is any variable.

If the i-th instruction is an addition instruction of the variable X and a constant, processing proceeds to step S1221.

If the i-th instruction is not an addition instruction of the variable X and a constant, processing proceeds to step S1241.

In step S1221, the counter variable search unit 121 sets an initial value 1 in a temporary variable j.

In step S1222, the counter variable search unit 121 determines whether a j-th instruction changes the value of the variable X.

If the j-th instruction changes the value of the variable X, processing proceeds to step S1223.

If the j-th instruction does not change the value of the variable X, processing proceeds to step S1224.

In step S1223, the counter variable search unit 121 compares the value of the temporary variable j with the value of the temporary variable i.

If the value of the temporary variable j is equal to the value of the temporary variable i, processing proceeds to step S1224.

If the value of the temporary variable j is different from the value of the temporary variable i, processing proceeds to step S1241.

In step S1224, the counter variable search unit 121 determines whether the j-th instruction is the last instruction of the control program 191.

If the j-th instruction is the last instruction of the control program 191, processing proceeds to step S1231.

If the j-th instruction is not the last instruction of the control program 191, processing proceeds to step S1225.

In step S1225, the counter variable search unit 121 adds 1 to the value of the temporary variable j.

After step S1225, processing proceeds to step S1222.

In step S1231, the counter variable search unit 121 adds the variable X in the i-th instruction to a counter variable list 193 as a counter variable.

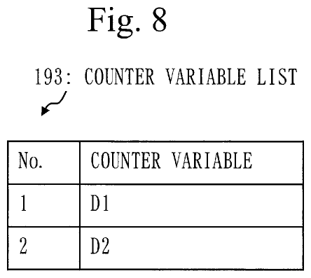

FIG. 8 illustrates an example of the counter variable list 193.

The counter variable list 193 indicates one or more counter variables. Each of “D1” and “D2” is a counter variable name.

Referring back to FIG. 7, the description will be continued from step S1241.

In step S1241, the counter variable search unit 121 determines whether the i-th instruction is the last instruction of the control program 191.

If the i-th instruction is the last instruction of the control program 191, processing ends.

If the i-th instruction is not the last instruction of the control program 191, processing proceeds to step S1242.

In step S1242, the counter variable search unit 121 adds 1 to the value of the temporary variable i.

After step S1242, processing proceeds to step S1212.

Referring back to FIG. 3, the description will be continued.

By step S120, the counter variable list 193 is obtained.

If a variable for counting the number of times the control program 191 is executed is defined in advance, the counter variable search unit 121 also adds that variable to the counter variable list 193.

In step S130, the remainder operation search unit 122 finds a remainder operation on a counter variable from the control program 191.

A remainder operation on a counter variable is a remainder operation in which the counter variable is a dividend and a constant is a divisor.

A remainder operation is an operation (instruction) for obtaining a remainder.

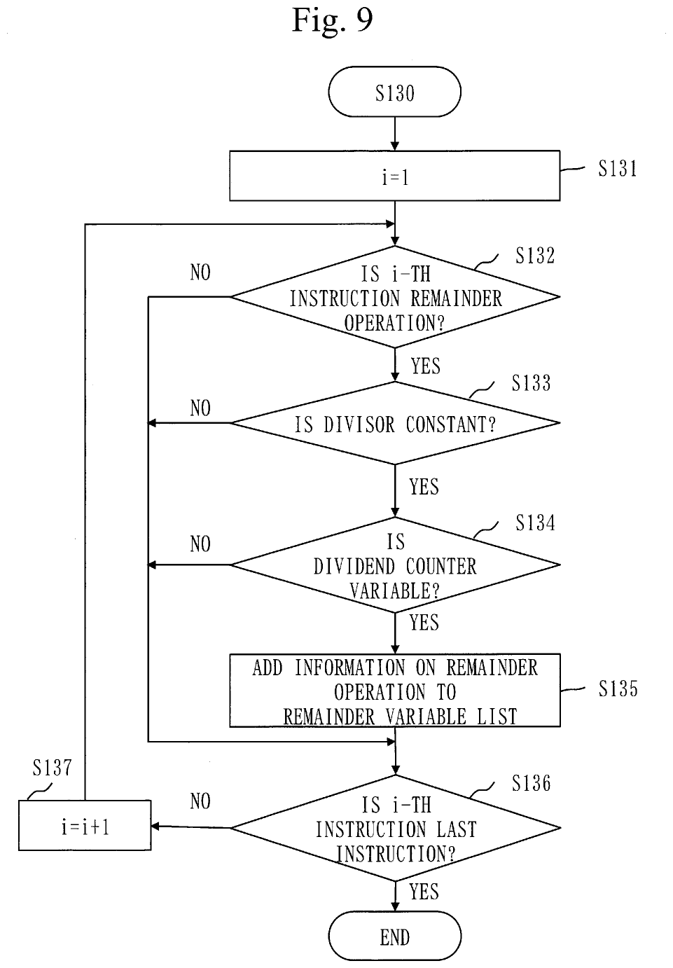

Based on FIG. 9, a procedure for step S130 will be described.

In step S131, the remainder operation search unit 122 sets an initial value 1 in the temporary variable i.

In step S132, the remainder operation search unit 122 selects the i-th instruction from the control program 191.

Then, the remainder operation search unit 122 determines whether the i-th instruction is a remainder operation.

If the i-th instruction is a remainder operation, processing proceeds to step S133.

If the i-th instruction is not a remainder operation, processing proceeds to step S136.

In step S133, the remainder operation search unit 122 determines whether a divisor P in the i-th instruction is a constant.

If the divisor P in the i-th instruction is a constant, processing proceeds to step S134.

If the divisor P in the i-th instruction is not a constant, processing proceeds to step S136.

In step S134, the remainder operation search unit 122 determines whether the dividend in the i-th instruction is a counter variable.

That is, the remainder operation search unit 122 determines whether the dividend in the i-th instruction is a variable indicated in the counter variable list 193.

If the dividend in the i-th instruction is a counter variable, processing proceeds to step S135.

If the dividend in the i-th instruction is not a counter variable, processing proceeds to step S136.

In step S135, the remainder operation search unit 122 adds information on the remainder operation that is the i-th instruction to a remainder variable list 194.

Specifically, the remainder operation search unit 122 adds a set of the name of the counter variable (dividend), the name of a remainder variable, the divisor, and an operation position to the remainder variable list 194.

The remainder variable is a variable to which a remainder is assigned.

The operation position is the position of the remainder operation in the control program 191. The value of the temporary variable i is set as the operation position.

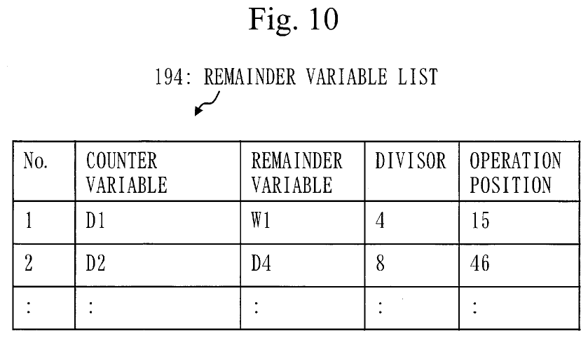

FIG. 10 illustrates an example of the remainder variable list 194.

The remainder variable list 194 indicates, as information on each remainder operation, a counter variable (dividend), a remainder variable, a divisor, and an operation position.

Referring back to FIG. 9, the description will be continued from step S136.

In step S136, the remainder operation search unit 122 determines whether the i-th instruction is the last instruction of the control program 191.

If the i-th instruction is the last instruction of the control program 191, processing ends.

If the i-th instruction is not the last instruction of the control program 191, processing proceeds to step S137.

In step S137, the remainder operation search unit 122 adds 1 to the value of the temporary variable i.

After step S137, processing proceeds to step S132.

Referring back to FIG. 3, the description will be continued.

By step S130, the remainder variable list 194 is obtained.

In step S140, the branch instruction search unit 123 finds a conditional branch instruction on a remainder from the control program 191.

A conditional branch instruction on a remainder is a conditional branch instruction, concerning the remainder of a remainder operation found in step S130, whose branch condition is a match between the remainder and a constant.

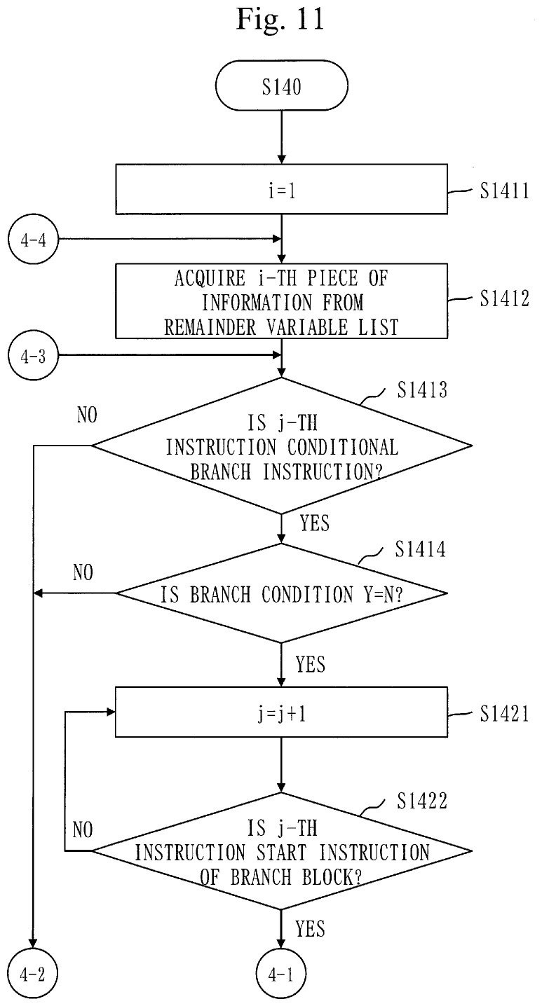

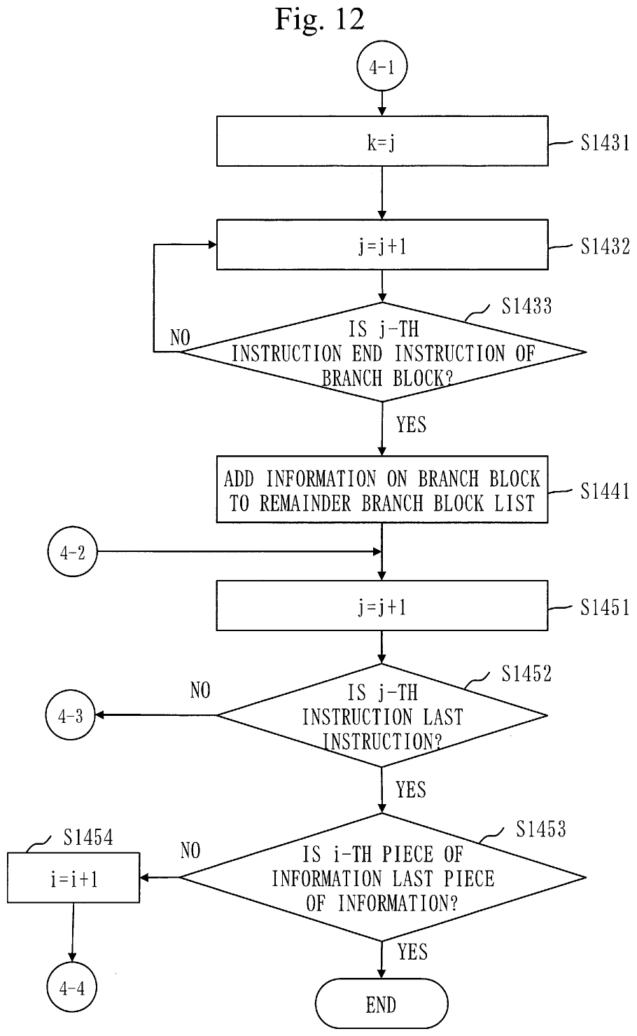

Based on FIGS. 11 and 12, a procedure for step S140 will be described.

In step S1411, the branch instruction search unit 123 sets an initial value 1 in the temporary variable i.

In step S1412, the branch instruction search unit 123 acquires an i-th piece of information from the remainder variable list 194.

Specifically, the branch instruction search unit 123 acquires a counter variable name (X), a remainder variable name (Y), a divisor P, and an operation position J.

Then, the branch instruction search unit 123 sets the operation position J in the temporary variable j as an initial value.

In step S1413, the branch instruction search unit 123 selects the j-th instruction from the control program 191.

Then, the branch instruction search unit 123 determines whether the j-th instruction is a conditional branch instruction.

If the j-th instruction is a conditional branch instruction, processing proceeds to step S1414.

If the j-th instruction is not a conditional branch instruction, processing proceeds to step S1451.

In step S1414, the branch instruction search unit 123 determines whether the branch condition in the j-th instruction is a match between a remainder variable Y and a constant N.

If the branch condition in the j-th instruction is a match between the remainder variable Y and the constant N, processing proceeds to step S1421.

If the branch condition in the j-th instruction is not a match between the remainder variable Y and the constant N, processing proceeds to step S1451.

In step S1421, the branch instruction search unit 123 adds 1 to the value of the temporary variable j.

In step S1422, the branch instruction search unit 123 selects the j-th instruction from the control program 191.

Then, the branch instruction search unit 123 determines whether the j-th instruction is the start instruction for the conditional branch instruction found in step S1413.

That is, the branch instruction search unit 123 determines whether the j-th instruction denotes start of a branch destination block.

If the j-th instruction is the start instruction for the conditional branch instruction found in step S1413, processing proceeds to step S1431.

If the j-th instruction is not the start instruction for the conditional branch instruction found in step S1413, processing proceeds to step S1421.

In step S1431, the branch instruction search unit 123 sets the value of the temporary variable j in a temporary variable k.

In step S1432, the branch instruction search unit 123 adds 1 to the value of the temporary variable j.

In step S1433, the branch instruction search unit 123 selects the j-th instruction from the control program 191.

Then, the branch instruction search unit 123 determines whether the j-th instruction is the end instruction for the conditional branch instruction found in step S1413.

That is, the branch instruction search unit 123 determines whether the j-th instruction denotes end of a branch destination block.

If the j-th instruction is the end instruction for the conditional branch instruction found in step S1413, processing proceeds to step S1441.

If the j-th instruction is not the end instruction for the conditional branch instruction found in step S1413, processing proceeds to step S1432.

In step S1441, the branch instruction search unit 123 adds information on a remainder branch block to a remainder branch block list 195.

The remainder branch block is the branch block for the conditional branch instruction found in step S1413.

Specifically, the branch instruction search unit 123 sets a set of a counter variable (dividend) name X, a remainder variable name Y, a divisor P, an operation position J, a constant N, a start position k, and an end position j to the remainder branch block list 195.

The constant N is referred to as a comparison constant.

The start position k is the start position of the branch destination block in the control program 191.

The end position j is the end position of the branch destination block in the control program 191.

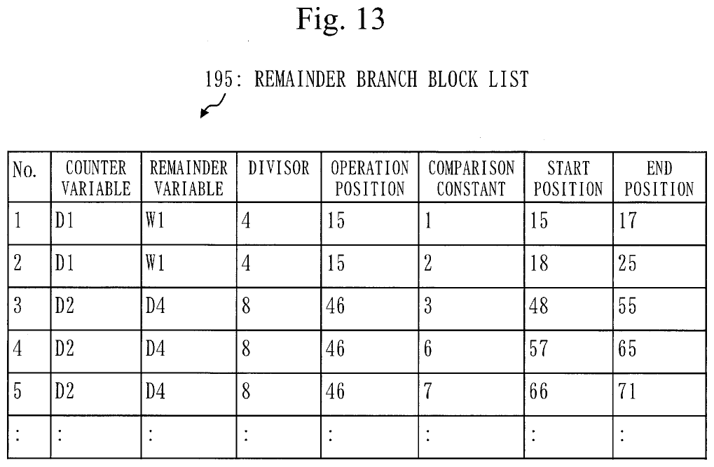

FIG. 13 illustrates an example of the remainder branch block list 195.

The remainder branch block list 195 indicates, as information on each remainder branch block, a counter variable (dividend), a remainder variable, a divisor, an operation position, a comparison constant, a start position, and an end position.

Referring back to FIG. 12, the description will be continued from step S1451.

In step S1451, the branch instruction search unit 123 adds 1 to the value of the temporary variable j.

In step S1452, the branch instruction search unit 123 selects the j-th instruction from the control program 191.

Then, the branch instruction search unit 123 determines whether the j-th instruction is the last instruction of the control program 191.

If the j-th instruction is the last instruction of the control program 191, processing proceeds to step S1453.

If the j-th instruction is not the last instruction of the control program 191, processing proceeds to step S1413.

In step S1453, the branch instruction search unit 123 determines whether the i-th piece of information is the last piece of information in the remainder variable list 194.

If the i-th piece of information is the last piece of information in the remainder variable list 194, processing ends.

If the i-th piece of information is not the last piece of information in the remainder variable list 194, processing proceeds to step S1454.

In step S1454, the branch instruction search unit 123 adds 1 to the value of the temporary variable i.

After step S1454, processing proceeds to step S1412.

Referring back to FIG. 3, the description will be continued.

By step S140, the remainder branch block list 195 is obtained.

In step S150, the input/output variable extraction unit 124 extracts an input/output variable from the branch destination block of the conditional branch instruction.

At this time, the input/output variable extraction unit 124 determines whether the branch destination block includes a jump instruction. Then, if the branch destination block does not include a jump instruction, the input/output variable extraction unit 124 extracts an input/output variable.

The target equipment identification unit 125 identifies the target equipment 220 corresponding to the extracted input/output variable.

The identified target equipment 220 is the target equipment 220 to or from which the value of the extracted input/output variable is input or output.

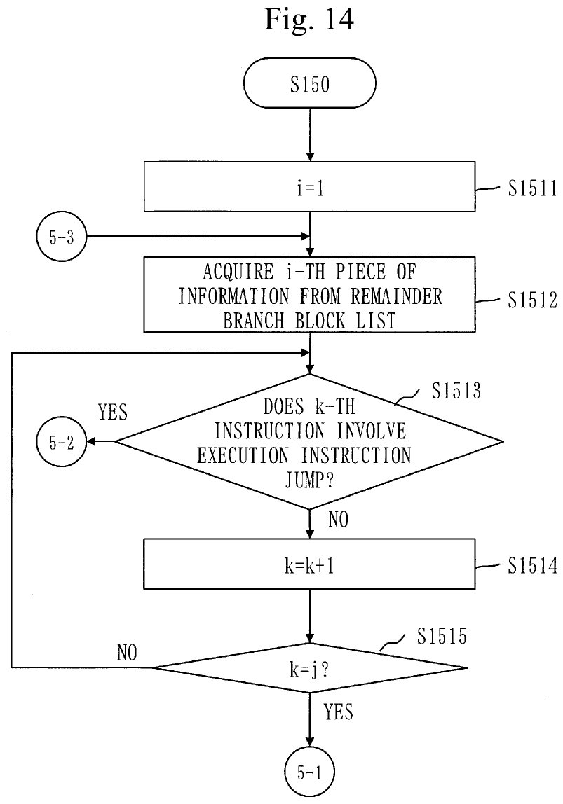

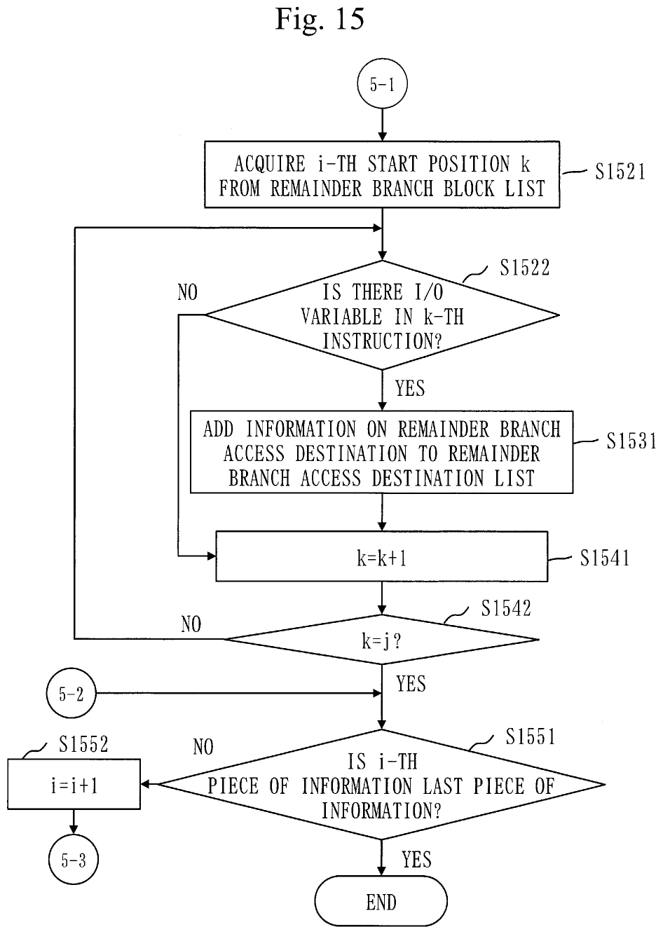

Based on FIGS. 14 and 15, a procedure for step S150 will be described.

In step S1511, the input/output variable extraction unit 124 sets an initial value 1 in the temporary variable i.

In step S1512, the input/output variable extraction unit 124 acquires the i-th piece of information from the remainder branch block list 195.

Specifically, the input/output variable extraction unit 124 acquires the counter variable name (X), the constant N, the start position, and the end position.

Then, the input/output variable extraction unit 124 sets the start position in the temporary variable k, and sets the end position in the temporary variable j.

In step S1513, the input/output variable extraction unit 124 selects a k-th instruction from the control program 191.

Then, the input/output variable extraction unit 124 determines whether the k-th instruction is an instruction involving an execution instruction jump.

If the k-th instruction is an instruction involving an execution instruction jump, processing proceeds to step S1551.

If the k-th instruction is not an instruction involving an execution instruction jump, processing proceeds to step S1514.

In step S1514, the input/output variable extraction unit 124 adds 1 to the value of the temporary variable k.

In step S1515, the input/output variable extraction unit 124 compares the value of the temporary variable k with the value of the temporary variable j.

If the value of the temporary variable k is equal to the value of the temporary variable j, processing proceeds to step S1521.

If the value of the temporary variable k is different from the value of the temporary variable j, processing proceeds to step S1513.

In step S1521, the input/output variable extraction unit 124 acquires an i-th start position from the remainder branch block list 195.

Then, the input/output variable extraction unit 124 sets the i-th start position in the temporary variable k.

In step S1522, the input/output variable extraction unit 124 selects the k-th instruction from the control program 191.

Then, the input/output variable extraction unit 124 determines whether an input/output variable indicated in the input/output variable list 192 is included in the k-th instruction as an operand.

If an input/output variable indicated in the input/output variable list 192 is included in the k-th instruction as an operand, processing proceeds to step S1531.

If an input/output variable indicated in the input/output variable list 192 is not included in the k-th instruction as an operand, processing proceeds to step S1541.

In step S1531, the target equipment identification unit 125 refers to the input/output variable list 192 to identify the target equipment 220 corresponding to the input/output variable in the k-th instruction.

Then, the target equipment identification unit 125 adds information on a remainder branch access destination to a remainder branch access destination list 196.

Specifically, the target equipment identification unit 125 adds a set of the counter variable (dividend) name X, the remainder variable name Y, the divisor P, the operation position J, the constant N, the start position k, the end position j, and an access destination to the remainder branch access destination list 196.

The access destination denotes the name of the target equipment 220 corresponding to the input/output variable in the k-th instruction.

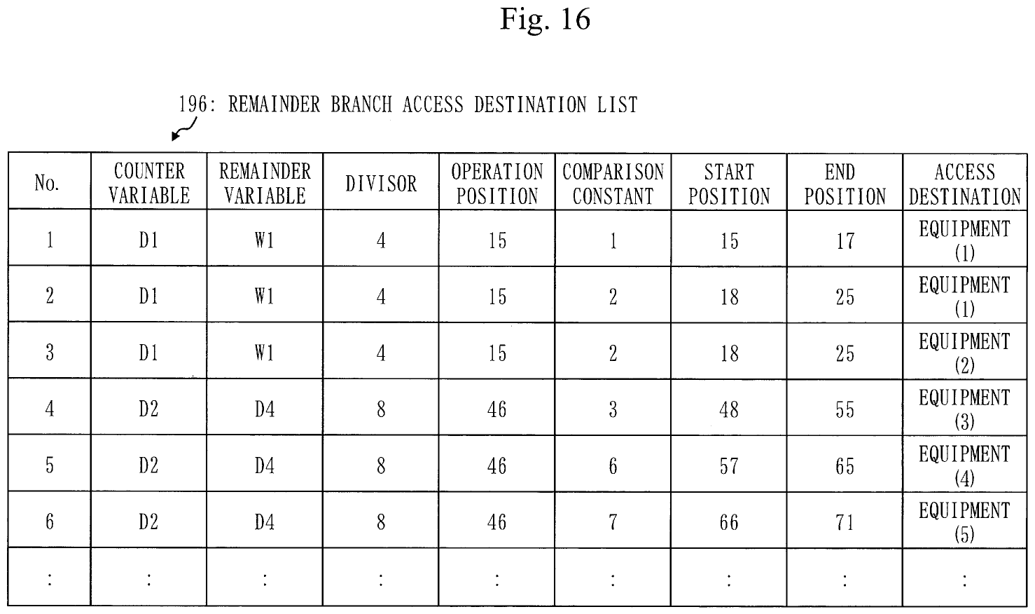

FIG. 16 illustrates the remainder branch access destination list 196.

The remainder branch access destination list 196 indicates, as information on each remainder branch access destination, a counter variable (dividend), a remainder variable, a divisor, an operation position, a comparison constant, a start position, an end position, and an access destination.

Referring back to FIG. 15, the description will be continued from step S1541.

In step S1541, the input/output variable extraction unit 124 adds 1 to the value of the temporary variable k.

In step S1542, the input/output variable extraction unit 124 compares the value of the temporary variable k with the value of the temporary variable j.

If the value of the temporary variable k is equal to the value of the temporary variable j, processing proceeds to step S1551.

If the value of the temporary variable k is different from the value of the temporary variable j, processing proceeds to step S1522.

In step S1551, the input/output variable extraction unit 124 determines whether the i-th piece of information is the last piece of information in the remainder branch block list 195.

If the i-th piece of information is the last piece of information in the remainder branch block list 195, processing ends.

If the i-th piece of information is not the last piece of information in the remainder branch block list 195, processing proceeds to step S1552.

In step S1552, the input/output variable extraction unit 124 adds 1 to the value of the temporary variable i.

After step S1552, processing proceeds to step S1512.

Referring back to FIG. 3, the description will be continued.

By step S150, the remainder branch access destination list 196 is obtained.

In step S160, the communication period determination unit 126 determines a communication period of each piece of the target equipment 220.

At this time, the communication period determination unit 126 determines whether the input/output variable is accessed only in one branch destination block. Then, if the input/output variable is accessed only in one branch destination block, the communication period determination unit 126 determines a time period obtained by multiplying the execution period of the control program 191 by the divisor of the remainder operation as the communication period of the target equipment 220 corresponding to the input/output variable. In addition, the communication period determination unit 126 determines the communication period of the rest of the target equipment 220 to be the execution period of the control program 191.

Specifically, the communication period determination unit 126 determines the communication period of each piece of the target equipment 220 as described below. “T” represents a base periodic communication period. The periodic communication period T is equal to the execution period of the control program 191.

The communication period determination unit 126 identifies the target equipment 220 that is indicated in only one piece of information in the remainder branch access destination list 196, and acquires the divisor P from the information on the identified target equipment 220. Then, the communication period determination unit 126 determines the periodic communication period of the identified target equipment 220 to be a value “T×p”.

The communication period determination unit 126 determines the periodic communication period of the rest of the target equipment 220 to be “T”.

In step S170, the setting unit 130 communicates with the control device 210 so as to set the control program 191 and the communication period of each piece of the target equipment 220 in the control device 210.

### *** Effects of Embodiment 1 ***

Embodiment 1 allows an appropriate communication period to be obtained for the target equipment 220 that is accessed once while the control program 191 is executed P times.

### *** Supplement to Embodiment 1 ***

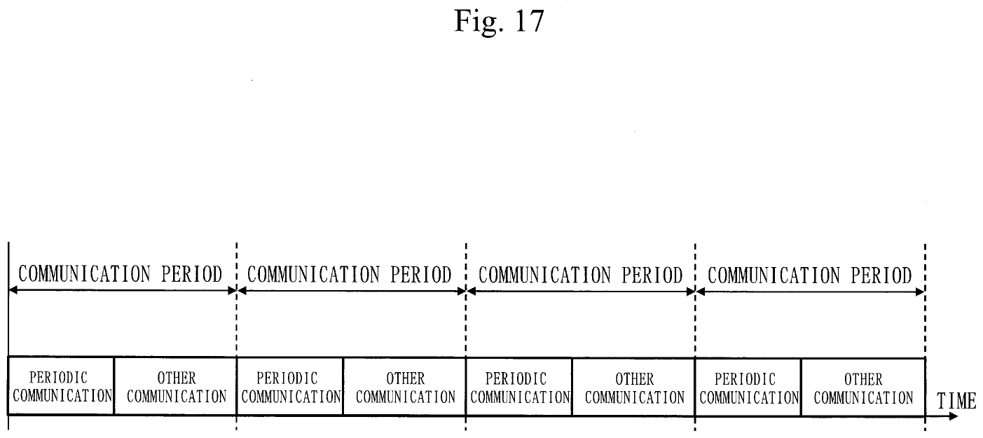

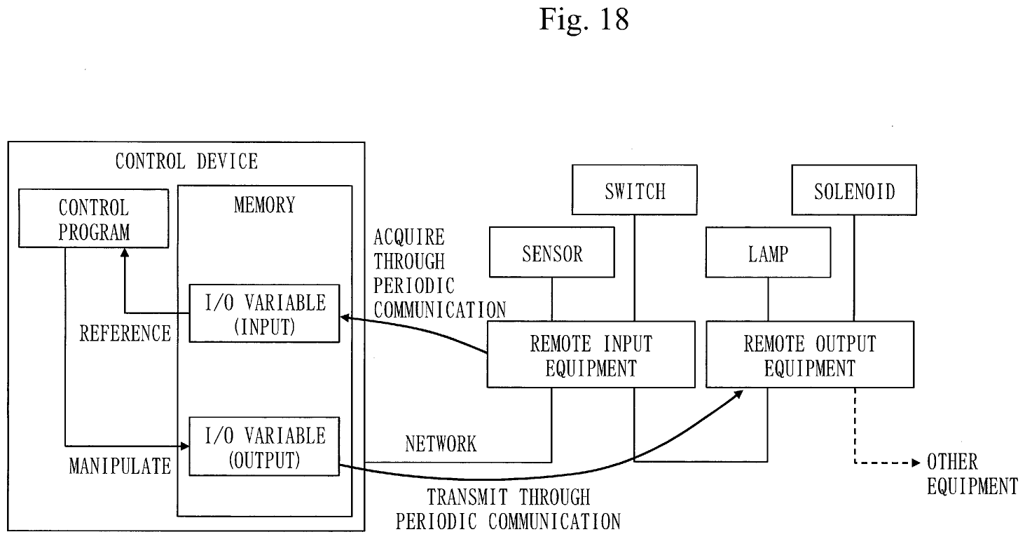

Based on FIGS. 17 and 18, periodic communication will be described.

Some FA networks have a periodic communication function using a time-division communication technique.

In the periodic communication function using the time-division communication technique (see FIG. 17), the communication band of a network is time-divided, and time frames of a communication period having a pre-determined time length are provided so as to perform communication whose details are predetermined.

When periodic communication is not performed, other types of communication can use the network.

The values of input/output variables are updated using periodic communication.

Periodic communication is performed independently of execution of a control program (see FIG. 18).

In periodic communication, input data acquired from remote input equipment is saved in a memory inside a control device, and the value of the input data is referenced by the control program as the value of an input/output variable. In addition, the value of an input/output variable manipulated by the control program is saved in the memory and is transmitted to remote output equipment through periodic communication.

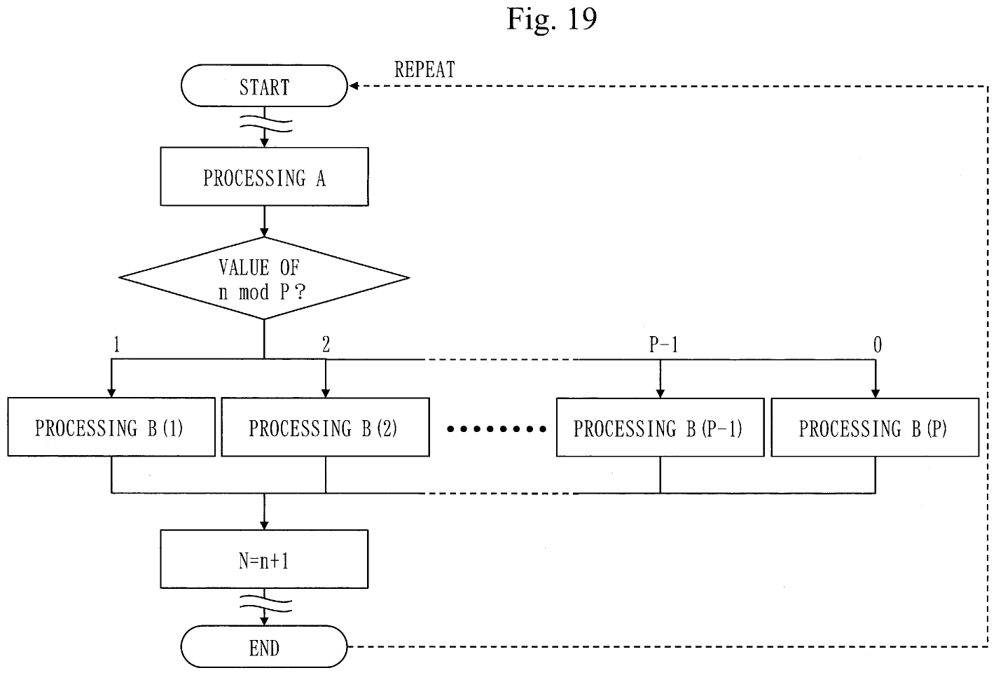

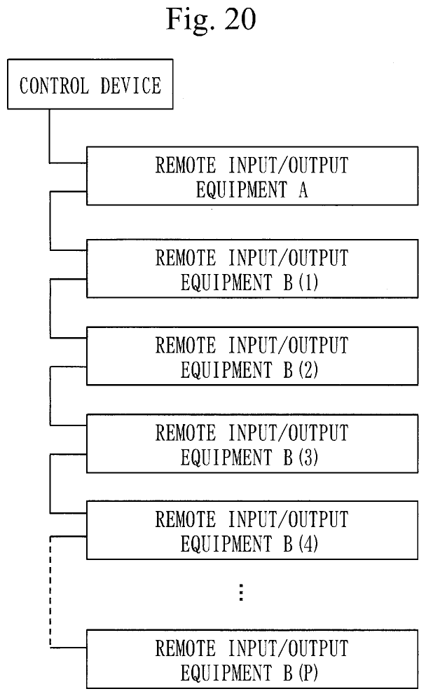

Based on FIGS. 19 and 20, the control program will be described supplementarily.

The control program is generally executed repeatedly with a fixed period.

The control program may include processing that is executed each time the control program is executed and processing that is executed only once while the control program is executed several times.

FIG. 19 illustrates an example of a flowchart of the control program.

For example, when the control program is executed, processing A is always executed. In contrast to this, processing B(1) is executed only when the remainder of dividing the value of a variable n by P is 1. Processing B(2) is executed only when the remainder of dividing the value of the variable n by P is 2. Processing B(P−1) is executed only when the remainder of dividing the value of the variable n by P is (P−1). Processing B(P) is executed only when the remainder of dividing the value of the variable n by P is 0.

The value of the variable n is incremented by 1 each time the control program is executed. In this case, each of the processing B(1) to the processing B(P) is executed once during each time period in which the control program is executed P times.

FIG. 20 illustrates an example of a configuration of remote input/output equipment.

It is assumed that there are remote input/output equipment A and remote input/output equipment B(1) to remote input/output equipment B(P). The processing A processes the input/output variable of the remote input/output equipment A. Similarly, the processing B(1) processes the input/output variable of the remote input/output equipment B(1), the processing B(2) processes the input/output variable of the remote input/output equipment B(2), and the processing B(P) processes the input/output variable of the remote input/output equipment B(P).

In this case, the input/output variable of the remote input/output equipment A is referenced or manipulated by the processing A. The input/output variable of the remote input/output equipment A needs to be updated each time the control program is executed.

On the other hand, the input/output variables of the remote input/output equipment B(1) to the remote input/output equipment B(P) are referenced or manipulated by the processing B(1) to the processing B(P), respectively. The input/output variables of the remote input/output equipment B(1) to the remote input/output equipment B(P) need to be updated every P executions of the control program.

In other words, it can be stated that the period of periodic communication appropriate for the remote input/output equipment B(1) to the remote input/output equipment B(P) is P times the period of periodic communication appropriate for the remote input/output equipment A.

Therefore, if the communication period of the remote input/output equipment B(1) to the remote input/output equipment B(P) is set to P times the communication period of the remote input/output equipment A, the amount of data exchanged in periodic communication will be reduced.

### Embodiment 2

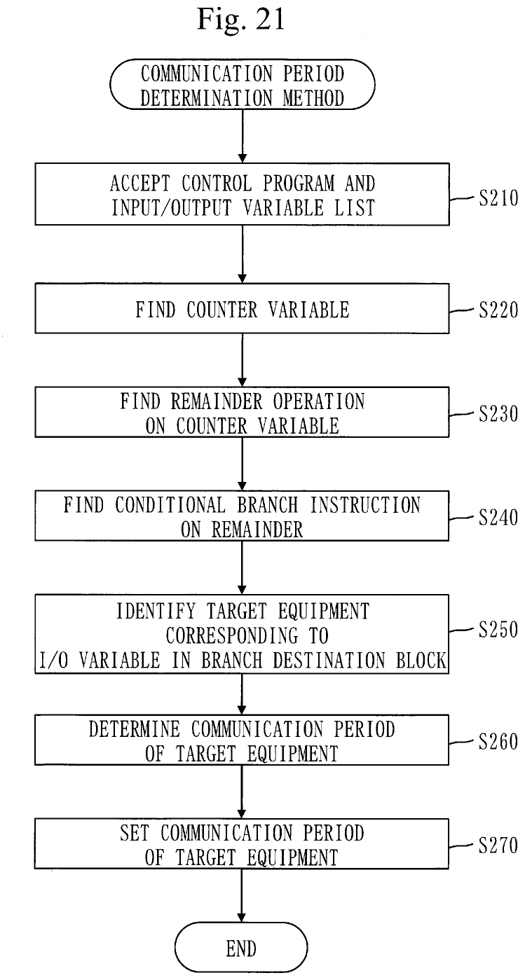

With regard to an embodiment in which the periodic communication period of the target equipment 220 that is indicated in a plurality of pieces of information in the remainder branch access destination list 196 is set to be longer than the periodic communication period T, differences from Embodiment 1 will be mainly described based on FIG. 21.

*** Description of Configuration ***

The configuration of the control system 200 and the configuration of the communication period determination device 100 are the same as the configurations in Embodiment 1.

*** Description of Operation ***

Based on FIG. 21, a communication period determination method will be described.

Steps S210 to S250 are the same as steps S110 to S150 in Embodiment 1.

Step S260 is partially different from step S160 in Embodiment 1.

Step S270 is the same as step S170 in Embodiment 1.

Step S260 will be described below.

In step S260, the communication period determination unit 126 determines a communication period of each piece of the target equipment 220.

At this time, the communication period determination unit 126 determines whether an input/output variable is accessed in two or more branch destination blocks. If the input/output variable is accessed in two or more branch destination blocks, the communication period determination unit 126 determines the communication period of the target equipment 220 corresponding to the input/output variable, based on the execution period of the control program 191, the divisor of the remainder operation, and two or more constants of two or more branch conditions corresponding to the two or more branch destination blocks.

Specifically, the communication period determination unit 126 determines the communication period of each piece of the target equipment 220 as described below. “T” represents the base periodic communication period. The periodic communication period T is equal to the execution period of the control program 191.

The communication period determination unit 126 identifies the target equipment 220 that is indicated only in one piece of information in the remainder branch access destination list 196. The identified target equipment 220 will be referred to as target equipment (1).

The communication period determination unit 126 acquires the divisor P from information on the target equipment (1).

The communication period determination unit 126 determines the periodic communication period of the target equipment (1) to be a value “T×P”.

The communication period determination unit 126 identifies the target equipment 220 that is indicated in a plurality of pieces of information in the remainder branch access destination list 196. The identified target equipment 220 will be referred to as target equipment (2).

The communication period determination unit 126 determines whether a plurality of remainder variables indicated in the plurality of pieces of information of the target equipment (2) are the same. If the plurality of remainder variables indicated in the plurality of pieces of information of the target equipment (2) are the same, the target equipment (2) will be referred to as target equipment (2A). With regard to the target equipment (2A), there are k comparison constants N and the divisor is “P”.

The communication period determination unit 126 determines whether every element Rᵢ of a sequence R is an positive integer with respect to an element Sᵢ of a sequence S based on the k comparison constants (N₁, N₂, . . . , Nₖ) arranged in ascending order. If every element Rᵢ of the sequence R is an positive integer, the target equipment (2A) will be referred to as target equipment (2B).

The communication period determination unit 126 determines a periodic communication period C_{C} of the target equipment (2B) as indicated below.

$${S}_{i} = \{ \begin{matrix}{N}_{i + 1} - {N}_{i} … ( 1 \leq i < k ) \\ {N}_{i} + P - {N}_{i} … ( i = k )\end{matrix} \qquad [ Formula 1 ]$$

$${R}_{i} = \frac{{S}_{i}}{{min}_{1 \leq j \leq k} {S}_{j}} \qquad [ Formula 2 ]$$

$${C}_{c} = T \times \frac{P}{{min}_{1 \leq j \leq k} {S}_{j}} \qquad [ Formula 3 ]$$

The communication period determination unit 126 determines the periodic communication period of the rest of the target equipment 220 to be “T”.

*** Effects of Embodiment 2 ***

In Embodiment 1 described above, the periodic communication period of the target equipment 220 that is indicated only in one row in the remainder branch access destination list 196 is determined.

However, there may be a case where the periodic communication period of the target equipment 220 that is indicated in a plurality of rows in the remainder branch access destination list 196 can be set to be longer than the execution period of the control program 191.

In such a case, with Embodiment 2 it is possible to determine a periodic communication period that is longer than the execution period of the control program 191 for the target equipment 220 that is indicated in a plurality of rows in the remainder branch access destination list 196.

### Embodiment 3

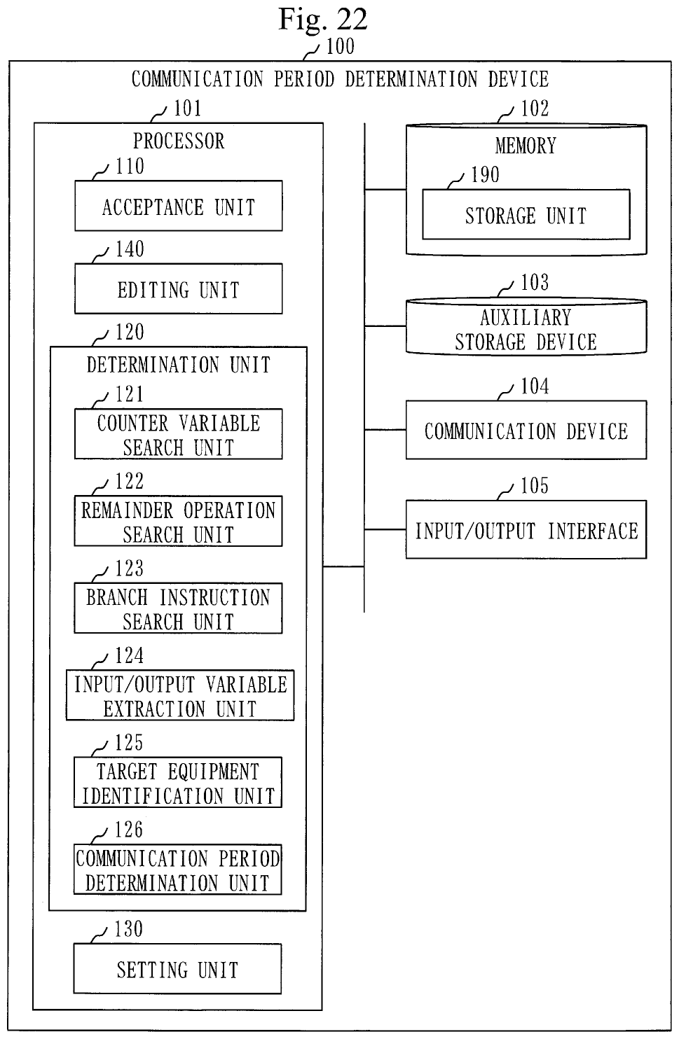

With regard to an embodiment in which consideration is given to variables in which constants are set, differences from Embodiments 1 and 2 will be mainly described based on FIGS. 22 to 24.

*** Description of Configuration ***

The configuration of the control system 200 is the same as the configuration in Embodiment 1.

Based on FIG. 22, the configuration of the communication period determination device 100 will be described.

The communication period determination device 100 further includes an editing unit 140.

The communication period determination program further causes a computer to function as the editing unit 140.

*** Description of Operation ***

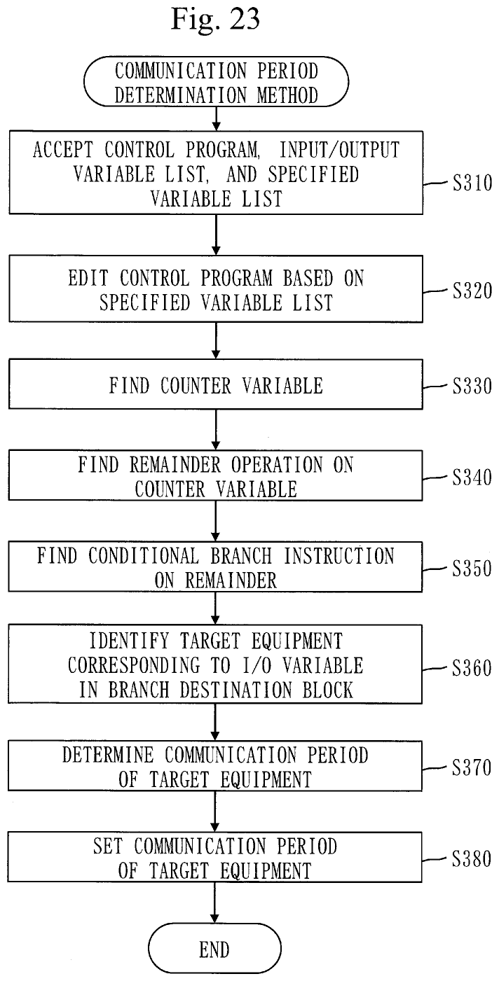

Based on FIG. 23, a communication period determination method will be described.

In step S310, the acceptance unit 110 accepts a specified variable list 197 in addition to the control program 191 and the input/output variable list 192.

The specified variable list 197 is a list of specified variables.

A specified variable is a variable in which a constant is set, and is specified by a user.

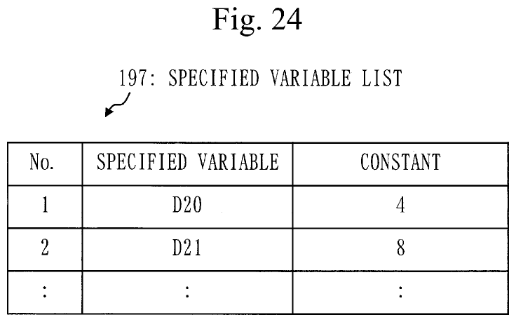

FIG. 24 illustrates an example of the specified variable list 197.

The specified variable list 197 indicates, for each specified variable, a specified variable and a constant.

The communication period determination device 100 may include a graphical user interface to assist creation of the specified variable list 197.

Referring back to FIG. 23, the description will be continued from step S320.

In step S320, the editing unit 140 edits the control program 191 based on the specified variable list 197.

Specifically, the editing unit 140 finds each specified variable from the control program 191, and replaces each specified variable in the control program 191 with a constant.

In steps S330 to S370, the edited control program 191 is used.

Steps S330 to S380 are the same as steps S120 to S170 in Embodiment 1 or steps S220 to S270 in Embodiment 2.

*** Effects of Embodiment 3 ***

Embodiment 1 above includes processing whose condition is that the operand of an instruction and the target of comparison are constants.

However, there may be a case where the control program 191 is created using a variable to represent a value that serves a role equivalent to a constant, and the value of this variable is fixed to a specific value at the beginning of the control program 191 or by a separate definition.

In such a case, with Embodiment 3, if the user individually specifies variables to which values to be treated as constants are assigned, these variables can be treated in the same way as constants.

### Embodiment 4

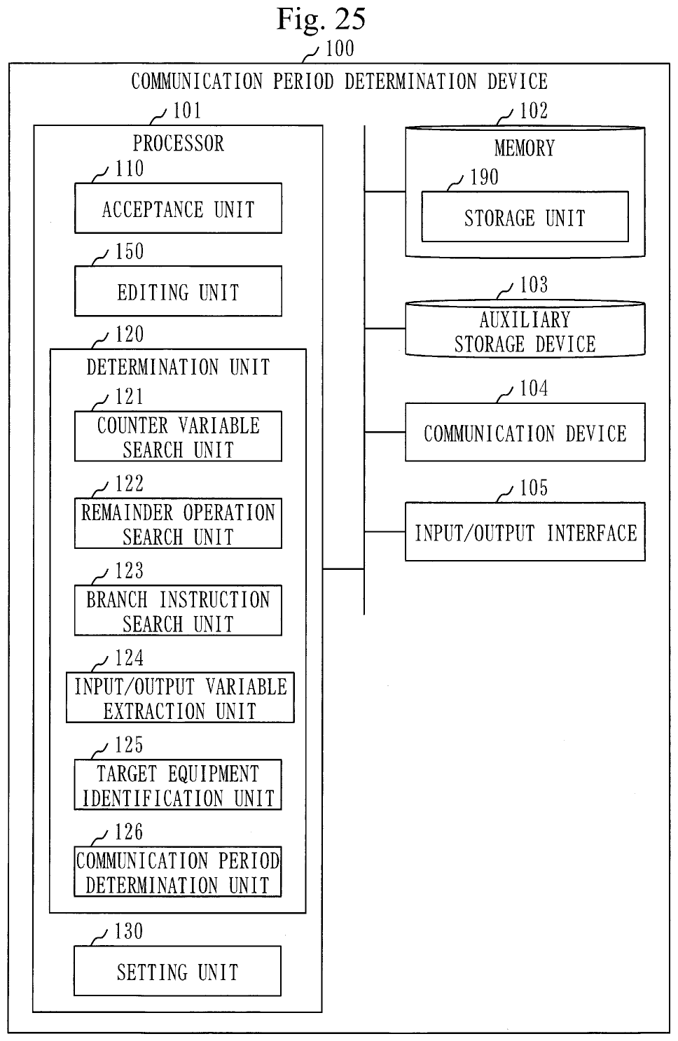

With regard to an embodiment in which consideration is given to branch instructions whose branch results are fixed, differences from Embodiments 1 and 2 will be mainly described based on FIGS. 25 to 28.

*** Description of Configuration ***

The configuration of the control system 200 is the same as the configuration in Embodiment 1.

Based on FIG. 25, the configuration of the communication period determination device 100 will be described.

The communication period determination device 100 further includes an editing unit 150.

The communication period determination program further causes a computer to function as the editing unit 150.

### *** Description of Operation ***

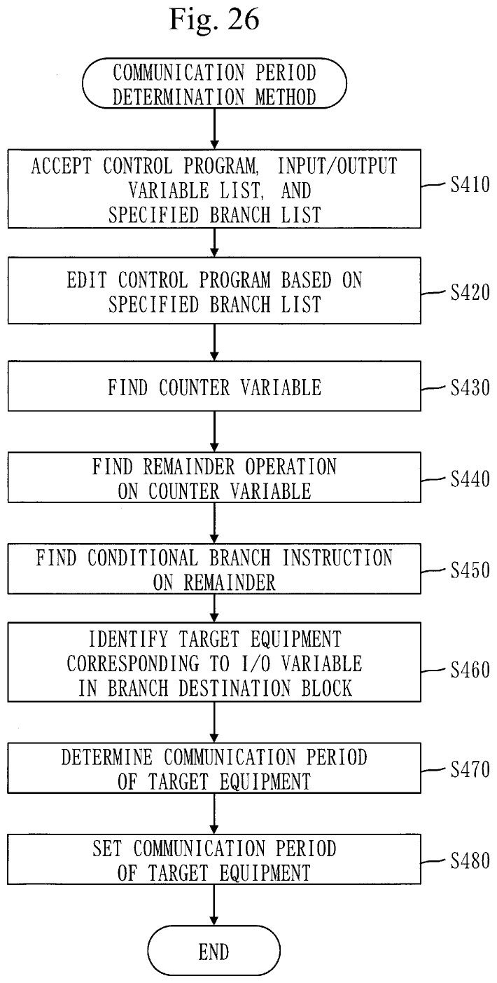

Based on FIG. 26, a communication period determination method will be described.

In step S410, the control device 210 accepts a specified branch list 198 in addition to the control program 191 and the input/output variable list 192.

The specified branch list 198 is a list of specified branch instructions.

A specified branch instruction is a branch instruction whose branch result is fixed, and is specified by a user.

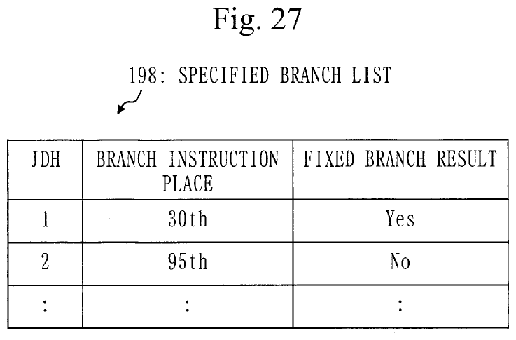

FIG. 27 illustrates an example of the specified branch list 198.

The specified branch list 198 indicates, for each specified branch instruction, a branch instruction place and a fixed branch result.

A branch instruction place is the place of a specified branch instruction in the control program 191.

A fixed branch result is a branch result that is fixed.

The communication period determination device 100 may include a graphical user interface to assist creation of the specified branch list 198.

Referring back to FIG. 26, the description will be continued from step S420.

In step S420, the editing unit 150 edits the control program 191 based on the specified branch list 198.

Specifically, the editing unit 150 finds each specified branch instruction from the control program 191, and fixes the branch result of each specified branch instruction in the control program 191 so as to disable it.

In steps S430 to step S470, the edited control program 191 is used.

Steps S430 to S480 are the same as steps S120 to S170 in Embodiment 1 or steps S220 to S270 in Embodiment 2.

*** Effects of Embodiment 4 ***

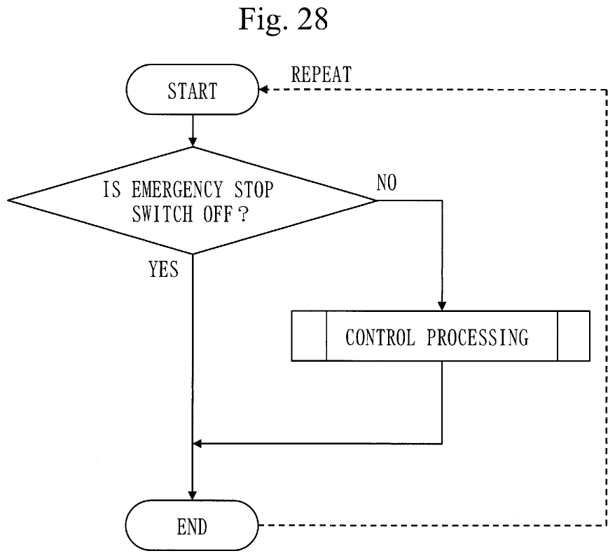

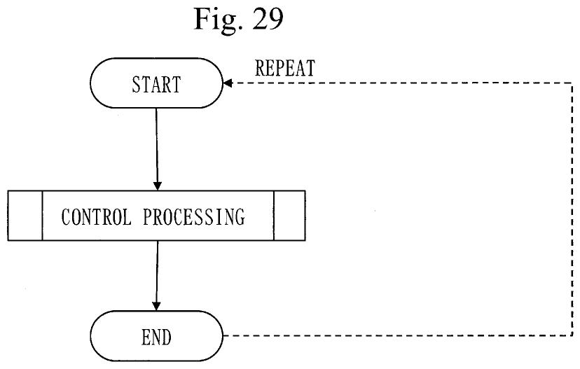

Each of FIGS. 28 and 29 illustrates an example of a flowchart of a control program.

In FIG. 28, the control program has a branch instruction in anticipation of an unsteady state, and control processing is not executed unless an emergency stop switch is turned on.

Such a control program has no instruction that is executed only once and the counter variable list is empty. When the counter variable list is empty, the embodiments cannot be applied.

In such a situation, Embodiment 4 fixes the branch result of a branch instruction specified by the user to one result. As a result, the specified branch instruction is practically disabled.

By fixing the branch result of the branch instruction “IS EMERGENCY STOP SWITCH OFF?” to “NO” in FIG. 28, it is practically possible to represent the control program as indicated in FIG. 29.

*** Supplement to Embodiment 4 ***

Embodiment 4 may be combined with Embodiment 3. That is, the communication period determination device 100 may include the editing unit 140 and the editing unit 150, and the control program 191 may be edited by the editing unit 140 and the editing unit 150.

*** Supplement to Embodiments ***

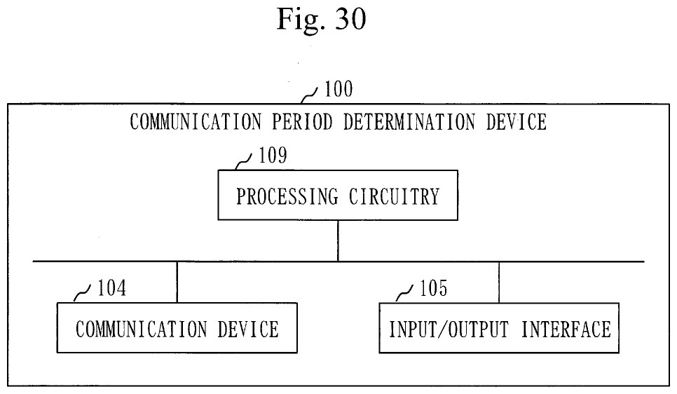

Based on FIG. 30, a hardware configuration of the communication period determination device 100 will be described.

The communication period determination device 100 includes processing circuitry 109.

The processing circuitry 109 is hardware that realizes the acceptance unit 110, the determination unit 120, the setting unit 130, the editing unit 140, and the editing unit 150.

The processing circuitry 109 may be dedicated hardware, or may be the processor 101 that executes programs stored in the memory 102.

When the processing circuitry 109 is dedicated hardware, the processing circuitry 109 is, for example, a single circuit, a composite circuit, a programmed processor, a parallel-programmed processor, an ASIC, an FPGA, or a combination of these.

ASIC is an abbreviation for application specific integrated circuit.

FPGA is an abbreviation for field programmable gate array.

The communication period determination device 100 may include a plurality of processing circuits as an alternative to the processing circuitry 109.

In the processing circuitry 109, some functions may be realized by dedicated hardware, and the remaining functions may be realized by software or firmware.

As described above, the functions of the communication period determination device 100 can be realized by hardware, software, firmware, or a combination of these.

Each of the embodiments is an example of a preferred embodiment and is not intended to limit the technical scope of the present disclosure. Each of the embodiments may be implemented partially or may be implemented in combination with another embodiment. The procedures described using the flowcharts or the like may be changed as appropriate.

The communication period determination device 100 may be realized by two or more devices.

Each “unit” that is an element of the communication period determination device 100 may be interpreted as “process”, “step”, “circuit”, or “circuitry”.

### REFERENCE SIGNS LIST

100: communication period determination device, 101: processor, 102: memory, 103: auxiliary storage device, 104: communication device, 105: input/output interface, 109: processing circuitry, 110: acceptance unit, 120: determination unit, 121: counter variable search unit, 122: remainder operation search unit, 123: branch instruction search unit, 124: input/output variable extraction unit, 125: target equipment identification unit, 126: communication period determination unit, 130: setting unit, 140: editing unit, 150: editing unit, 190: storage unit, 191: control program, 192: input/output variable list, 193: counter variable list, 194: remainder variable list, 195: remainder branch block list, 196: remainder branch access destination list, 197: specified variable list, 198: specified branch list, 200: control system, 201: network, 202: network, 210: control device, 220: target equipment, 221: sensor, 222: switch, 223: lamp, 224: solenoid, 230: setting device.

1. A communication period determination device comprising
processing circuitry to:
find, from a control program for controlling one or more pieces of target equipment, a counter variable for counting the number of times the control program is executed;
find, from the control program, a remainder operation in which the counter variable is a dividend and a constant is a divisor;
find, from the control program, a conditional branch instruction whose branch condition is a match between a remainder of the remainder operation and a constant;
extract an input/output variable from a branch destination block of the conditional branch instruction;
identify, from among the one or more pieces of target equipment, a piece of target equipment to or from which a value of the extracted input/output variable is input or output; and
determine a time period obtained by multiplying an execution period of the control program by the divisor of the remainder operation as a communication period of the identified piece of target equipment when the extracted input/output variable is accessed in only one branch destination block.

2. The communication period determination device according to claim 1,
wherein the processing circuitry determines a communication period of each remaining piece of target equipment of the one or more pieces of target equipment to be the execution period.

3. The communication period determination device according to claim 1,
wherein the processing circuitry determines whether the branch destination block includes a jump instruction, and extracts the input/output variable when the branch destination block does not include the jump instruction.

4. The communication period determination device according to claim 1,
wherein when the extracted input/output variable is accessed in two or more branch destination blocks, the processing circuitry determines a communication period of the identified piece of target equipment, based on the execution period, the divisor, and two or more constants of two or more branch conditions corresponding to the two or more branch destination blocks.

5. The communication period determination device according to claim 4,
wherein the processing circuitry determines whether every element Rᵢ of a sequence R is a positive integer with respect to an element Sᵢ of a sequence S based on the two or more constants, N₁ to Nₖ, arranged in ascending order, and determines a communication period C_{C} of the identified piece of target equipment when every element Rᵢ is a positive integer, and
wherein the element Sᵢ, the element and the communication period C_{C} are as indicated below
$${S}_{i} = \{ \begin{matrix}{N}_{i + 1} - {N}_{i} … ( 1 \leq i < k ) \\ {N}_{i} + P - {N}_{i} … ( i = k )\end{matrix} \qquad [ Formula 11 ]$$
$${R}_{i} = \frac{{S}_{i}}{{min}_{1 \leq j \leq k} {S}_{j}} \qquad [ Formula 12 ]$$
$${C}_{c} = T \times \frac{P}{{min}_{1 \leq j \leq k} {S}_{j}} . \qquad [ Formula 13 ]$$

6. The communication period determination device according to claim 1,
wherein the processing circuitry finds, from the control program, a specified variable that is specified as a variable in which a constant is set, and edits the control program by replacing the specified variable in the control program with the constant to be set in the specified variable, and
wherein a communication period of the identified piece of target equipment is determined using the control program that has been edited.

7. The communication period determination device according to claim 1,
wherein the processing circuitry finds, from the control program, a specified branch instruction that is specified as a branch instruction whose branch result is fixed, and edits the control program so as to fix the branch result of the specified branch instruction in the control program, and
wherein a communication period of the identified piece of target equipment is determined using the control program that has been edited.

8. The communication period determination device according to claim 1,
wherein the processing circuitry finds, from the control program, a specified variable that is specified as a variable in which a constant is set, and edits the control program by replacing the specified variable in the control program with the constant to be set in the specified variable,
wherein the processing circuitry finds, from the control program, a specified branch instruction that is specified as a branch instruction whose branch result is fixed, and edits the control program so as to fix the branch result of the specified branch instruction in the control program, and
wherein a communication period of the identified piece of target equipment is determined using the control program that has been edited.

9. A communication period determination method comprising:
finding, from a control program for controlling one or more pieces of target equipment, a counter variable for counting the number of times the control program is executed;
finding, from the control program, a remainder operation in which the counter variable is a dividend and a constant is a divisor;
finding, from the control program, a conditional branch instruction whose branch condition is a match between a remainder of the remainder operation and a constant;
extracting an input/output variable from a branch destination block of the conditional branch instruction;
identifying, from among the one or more pieces of target equipment, a piece of target equipment to or from which a value of the extracted input/output variable is input or output; and
determining a time period obtained by multiplying an execution period of the control program by the divisor of the remainder operation as a communication period of the identified piece of target equipment when the extracted input/output variable is accessed in only one branch destination block.

10. A non-transitory computer readable medium storing a communication period determination program to cause a computer to execute:
a counter variable search process of finding, from a control program for controlling one or more pieces of target equipment, a counter variable for counting the number of times the control program is executed;
a remainder operation search process of finding, from the control program, a remainder operation in which the counter variable is a dividend and a constant is a divisor;
a branch instruction search process of finding, from the control program, a conditional branch instruction whose branch condition is a match between a remainder of the remainder operation and a constant;
an input/output variable extraction process of extracting an input/output variable from a branch destination block of the conditional branch instruction;
a target equipment identification process of identifying, from among the one or more pieces of target equipment, a piece of target equipment to or from which a value of the extracted input/output variable is input or output; and
a communication period determination process of determining a time period obtained by multiplying an execution period of the control program by the divisor of the remainder operation as a communication period of the identified piece of target equipment when the extracted input/output variable is accessed in only one branch destination block.
